(19) United States
(12) Patent Application Publication
(10) Pub. No.: US 2017/0008621 A1
(43) Pub. Date: Jan. 12, 2017

(54) ACCURATE OBJECT DETECTION IN FREE SPACE USING CONTROLLED LIGHT SOURCE TECHNIQUES

(71) Applicant: HONEYWELL INTERNATIONAL INC., Morristown, NJ (US)

(72) Inventors: Bernard Fritz, Eagan, MN (US); Andrew Peter Vechart, Plymouth, MN (US); Paul Frederick Dietrich, Brooklyn Park, MN (US); Rich Olson, Eagan, MN (US)

(73) Assignee: HONEYWELL INTERNATIONAL INC., Morristown, NJ (US)

(21) Appl. No.: 14/793,849

(22) Filed: Jul. 8, 2015

(51) Int. Cl. B64C 27/00

(52) U.S. Cl. CPC B64C 27/008

(57) ABSTRACT

An improved rotorcraft blade tracking system and method is provided. The provided blade tracking system and method projects a focused beam of light with minimal variance in predetermined spectral characteristics at the ranges of distance suitable for rotorcraft blade tracking applications. The provided system and method detects a reflected beam of light that is associated with the projected focused beam of light. The provided system and method maintains eye safety, and performs consistently over a variety of environmental conditions.

### TECHNICAL FIELD

Embodiments of the subject matter described herein relate generally to object detection in free space and, more particularly, to implementing controlled light source techniques in rotorcraft blade tracking.

### BACKGROUND

Rotorcraft blade tracking is generally considered a mid-range application of object detection in free space. Rotorcraft blade tracking is typically employed in rotorcraft design to monitor a rotorcraft's balance, reduce noise, and reduce excess vibration throughout the rotorcraft frame; in turn, rotorcraft blade tracking reduces wear, tear, and erosion of rotorcraft components. Two locations on the rotorcraft are typically referenced in rotorcraft blade tracking systems: a location for a rotorcraft blade tracking system, and a location of a target (typically on a rotorcraft blade) of the blade tracking system. Because rotorcraft sizes and configurations vary, there is a corresponding range of distances between these two locations.

Blade tracking systems are typically passive optic systems, which record the time when the shadow of a rotorcraft blade passes over designated collection optics. As may be readily appreciated, passive optic systems often suffer from inconsistent operation in response to various external factors. First, varying environmental conditions may affect the shadows of rotorcraft blades. Another external factor is the variation in the condition of the rotorcraft blades themselves. Additionally, passive optic blade tracking systems tend to have difficulty achieving consistent signal return over the typical range of distances that a current rotorcraft designs present. Inconsistent operation translates into poor performance.

Accordingly, an improved rotorcraft blade tracking system and method is desirable. The desired blade tracking system and method employs a controlled light source and projects a focused, beam, having minimal variance in beam diameter over the range of distances suitable for rotorcraft blade tracking applications. The desired system and method maintains eye safety, and operates consistently over a variety of external factors. The present invention provides the desired features.

### BRIEF SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

A blade tracking system for a rotorcraft is provided. The system comprises: a light source mounted on the rotorcraft and configured to generate a projected beam of light sufficient to impinge on a target on a blade of the rotorcraft, the target separated by a predetermined distance from the light source; an optical assembly coupled to the light source, and oriented to (i) direct the projected beam of light toward the target and (ii) focus the projected beam of light, such that the projected beam of light provides predetermined spectral characteristics along a predetermined range of distances; and a detector coupled to the light source and the optical assembly and configured to detect from the target, a reflected beam of light associated with the projected beam of light.

Another blade tracking system for a rotorcraft is provided. The blade tracking system comprises: a light source mounted on the rotorcraft and configured to generate a projected beam of light; an optical assembly coupled to the light source and oriented to (i) direct the projected beam of light such that it impinges on a target located on a blade of the rotorcraft, (ii) focus the projected beam of light, such that the projected beam of light comprises at least one predetermined spectral characteristic from the set of: (i) predetermined wavelength, (ii) predetermined spatial extent, (iii) predetermined aperture, and (iv) predetermined divergence along a predetermined range of distances; and a detector coupled to the optical assembly and the light source, the detector oriented to detect, from the target, a reflected beam of light associated with the projected beam of light.

A method for tracking a blade on a rotorcraft is also provided. The method comprises: generating, by a light source, a projected beam of light; redirecting, by an optical assembly, the projected beam of light toward a target located on a blade of the rotorcraft that is within a predetermined range of distances; focusing the projected beam of light such that the projected beam of light is characterized by at least one of: (i) predetermined wavelength, (ii) predetermined spatial extent, (iii) predetermined aperture, and (iv) predetermined divergence; and detecting, by a detector, a reflected beam of light from the target.

Other desirable features will become apparent from the following detailed description and the appended claims, taken in conjunction with the accompanying drawings and this background.

### BRIEF DESCRIPTION OF THE DRAWINGS

A more complete understanding of the subject matter may be derived by referring to the following Detailed Description and Claims when considered in conjunction with the following figures, wherein like reference numerals refer to similar elements throughout the figures, and wherein:

FIG. 1 is a simplified diagram of a rotorcraft employing a light beam blade tracking system, in accordance with an exemplary embodiment;

FIG. 2 is a block diagram of a light beam blade tracking system, in accordance with an exemplary embodiment;

FIG. 3 is an illustration showing additional detail of the light beam blade tracking system of FIG. 2, in accordance with an exemplary embodiment;

FIG. 4 is an illustration showing additional detail of the light beam blade tracking system of FIG. 2, in accordance with another exemplary embodiment;

FIG. 5 is an illustration showing additional detail of the light beam blade tracking system of FIG. 2, in accordance with yet another exemplary embodiment;

FIG. 6 is an intensity profile comparison of exemplary embodiments at 5 meters, without and with an axicon;

FIG. 7 is an intensity profile comparison of exemplary embodiments at 10 meters, without and with an axicon; and

FIG. 8 is an intensity profile comparison of exemplary embodiments at 12 meters, without and with an axicon.

### DETAILED DESCRIPTION

The following Detailed Description is merely exemplary in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over any other implementations. Furthermore, there is no intention to be bound by any expressed or implied theory presented in the preceding Technical Field, Background, Brief Summary or the following Detailed Description. Additionally, the connecting lines shown in the various figures contained herein are intended to represent exemplary functional relationships and/or physical couplings between the various elements. It should be noted that many alternative or additional functional relationships or physical connections may be present in an embodiment of the subject matter.

Techniques and technologies may be described herein in terms of functional and/or logical block components and with reference to symbolic representations of operations, processing tasks, and functions that may be performed by various computing components or devices. It should be appreciated that various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

Mechanisms to control components such as the source of laser light 202 and/or detector 216 may be electrical and/or mechanical, and may utilize processors and memory. Such operations, tasks, and functions are sometimes referred to as being processor-executed, computer-executed, computerized, software-implemented, or computer-implemented. In practice, one or more processor devices can carry out the described operations, tasks, and functions by manipulating electrical signals representing data bits at memory locations in the processor electronics of the display system, as well as other processing of signals. The memory locations where data bits are maintained are physical locations that have particular electrical, magnetic, optical, or organic properties corresponding to the data bits.

The following descriptions may refer to elements, nodes or features being “coupled” together. As used herein, and consistent with the discussion hereinabove, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements, additional intervening elements, devices, features, or components may be present in an embodiment of the depicted subject matter. In addition, certain terminology may also be used in the following description for the purpose of reference only, and thus are not intended to be limiting.

The embodiments described herein are merely examples and serve as guides for implementing the novel methods and systems in any avionics, astronautics, terrestrial, or water application. As used herein, an “a beam of light” comprises predetermined spectral characteristics such as, one or more predetermined wavelengths of light having a predetermined divergence (angular divergence of the beam of light as it extends from the source), predetermined aperture (maximum diameter of the beam of light), and a predetermined spatial extent (area) at a spot where the beam of light impinges on a target. Each of the below described embodiments employ a controlled, focused, light source to consistently produce the predetermined spectral characteristics along a predetermined range of distances. The examples presented herein are intended as non-limiting.

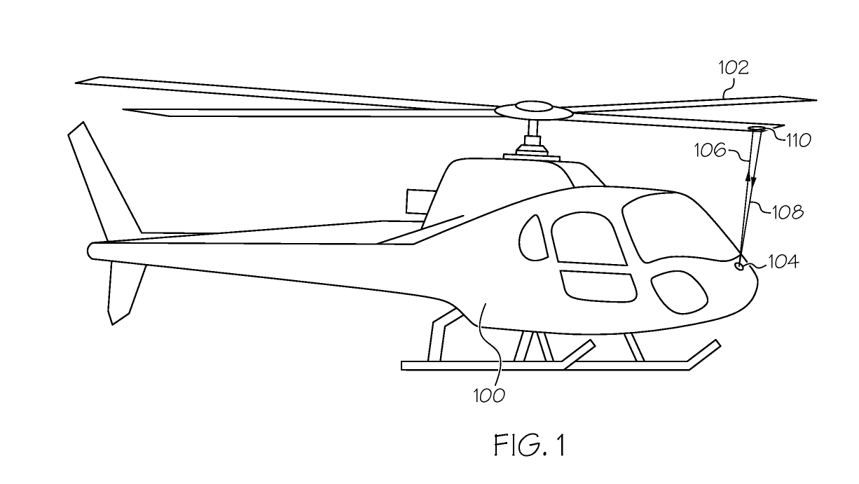

FIG. 1 is a simplified diagram of a rotorcraft 100 employing a light beam blade tracking system 104 according to an exemplary embodiment. While the light beam blade tracking system 104 is shown mounted to rotorcraft 100, and target 110 is shown as an area on blade 102 of rotorcraft 100, it is readily appreciated that the methods and systems described herein may be employed in non-rotorcraft applications without deviating from the scope of the invention. Various embodiments of the light beam blade tracking system 104 are described as follows.

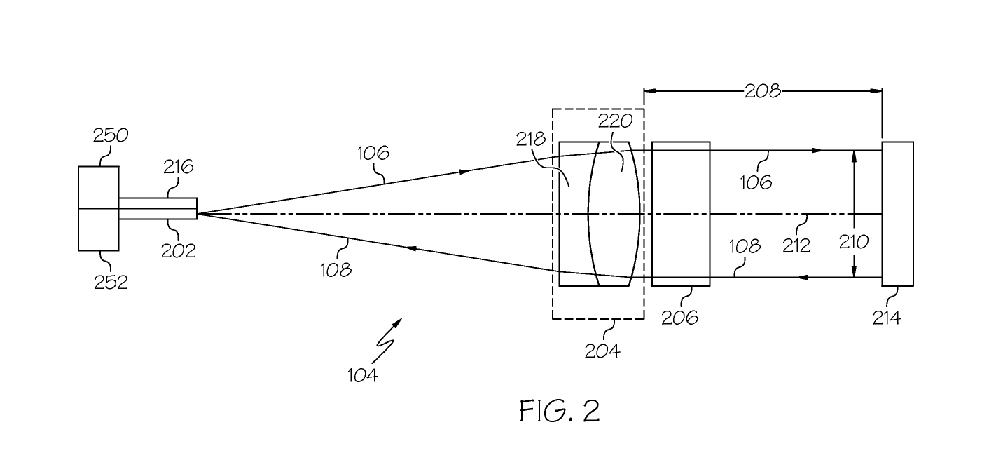

A light source (such as FIG. 2, source of laser light 202) generates a projected beam of light 106 sufficient to impinge on a target located within a predetermined range of distances from the light source. Various light sources, such as lasers, single mode optical fiber, multi-mode optical fiber, laser diodes, pinholes, or the like, may be utilized for the light source. In an embodiment, a laser diode may be coupled to an optical fiber, and the two elements may function as one light source. The output laser light may be unpolarized or polarized.

In an embodiment, the light source is selected and/or adjusted to ensure that the projected beam of light 106 has required spectral characteristics and content, such as a predetermined focal length and predetermined intensity profile (for example a Gaussian profile), at a “spot” having a predetermined diameter and consistently provided along a predetermined range of distances from the light beam blade tracking system. The predetermined range of distances is selected from a range of distances suitable for rotorcraft blade tracking applications, as described above; in some embodiments, the predetermined range of distances is from about 4 meters to about 12 meters.

Rotorcraft blade 102 includes target 110. Projected beam of light 106 impinges on a location on target 110. Target 110 responds to the impingement of projected beam of light 106 by reflecting light associated with the projected beam of light 106 back toward the light beam blade tracking system 104. Herein, the reflected light is referred to as the reflected beam of light 108. The reflected beam of light 108 may or may not comprise substantially the same spectral content as the projected beam of light 106. Wavelengths of ambient light and sunlight also directly or indirectly strike the light beam blade tracking system 104. The light beam blade tracking system 104 advantageously employs devices and methods to detect the reflected beam of light 108 from among wavelengths of sunlight and/or wavelengths of ambient light. Details of the projection and detection methods and mechanisms are described in more detail in connection with FIGS. 2-5.

FIG. 2 is a block diagram of a light beam blade tracking system 104, in accordance with an exemplary embodiment. FIG. 2 is not to scale but provides a visual appreciation for the relative position and orientation of components and features according to an embodiment. Source of laser light 202 and optical assembly 204 are each located and configured at a distance 208 from target 214. Source of laser light 202 generates projected beam of light 106. Optical assembly 204 is oriented to direct and focus projected beam of light 106, such that it provides predetermine spectral characteristics at a predetermined range of distances. The processor 250 may control aspects of the configuration of the source of laser light 202 and/or generation of the projected beam of light 106.

In an embodiment, the cooperation of the source of laser light 202 and optical assembly 204 produce the projected beam of light 106, having the required focal length, forming (at the target 214) a “spot” with the required spectral characteristics, such as predetermined spectral content, a predetermined intensity profile, and a predetermined diameter 210. The spot size is related to spatial resolution and range of distance between the source of the projection and the target. In some embodiments, the predetermined diameter may be between two to five millimeters. The light beam blade tracking system 104 consistently produces the spot with the required predetermined spectral characteristics along a predetermined range of distances 208 (from optical assembly 204 to the target 214); this predetermined range of distances 208 may be from about four to about twelve meters (this range may be called mid-range in comparison to other object detection methods), and is a suitable range for rotorcraft blade detection.

The projected beam of light 106 has the predetermined spectral characteristics at the location where it impinges on the target 214. In response to the impingement of the projected beam of light 106, target 214 scatters some amount of the projected beam of light 106, and the target 214 reflects at least some of the spectral content of the projected beam of light 106 back through the optical assembly 204, and ultimately toward the detector 216, this reflected light is referred to herein as the reflected beam of light 108. While projected beam of light 106 and reflected beam of light 108 are each shown in FIGS. 2-5 as a discrete beam in two dimensions, it is readily appreciated that, in practice, they each may be three dimensional, exhibit divergences, and each may comprise a single wavelength of light or a narrow band of wavelengths of light.

Generally, the detector 216 generally receives and detects wavelengths of light; specifically, the detector 216 is configured to detect/distinguish, from among other wavelengths of light, such as unwanted solar and ambient light, the reflected beam of light 108 associated with the projected beam of light 106.

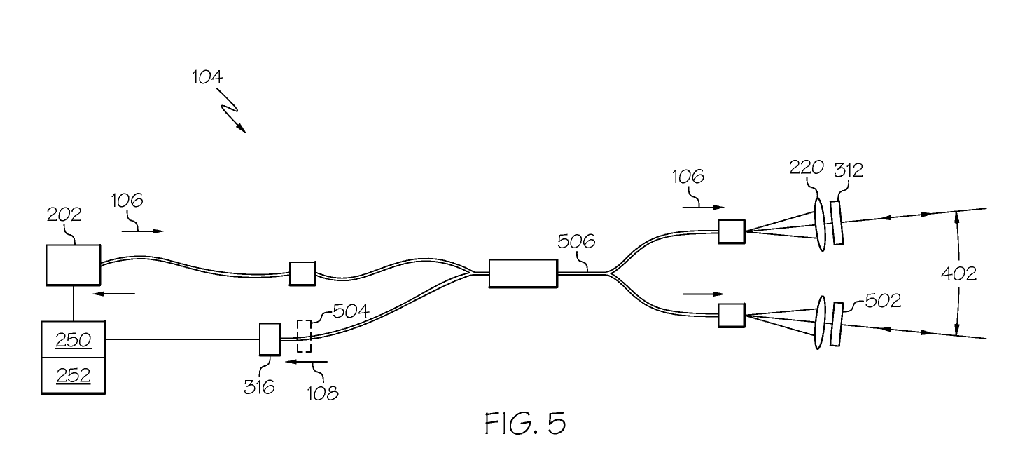

Distinguishing the reflected beam of light 108 may require removing unwanted wavelengths of light, such as solar light and ambient light. To do so, one or more application-specific bandpass filters 206 may be employed. In an embodiment, the pass frequency of a bandpass filter 206 is chosen to pass (or match) the wavelengths of reflected beam of light 108. In an embodiment, wavelengths of light not matching the wavelengths of reflected beam of light 108 are blocked or filtered out by the bandpass filter 206. Bandpass filters 206 may be chosen to pass a single wavelength, or a narrow band of wavelengths, consistent with the wavelengths of the reflected beam of light 108. Operationally, bandpass filters 206 may be located at several different locations within the light beam blade tracking system 104; in one embodiment, bandpass filter 206 is coupled to the detector 216. It is contemplated that bandpass filters 206 may also be configured at other locations within the light beam blade tracking system 104 (for example, see FIG. 5).

The source of laser light 202 and the detector 216 are each coupled to a processor 250 and memory 252. The processor 250 and memory 252 may coordinate to (i) control the source of laser light 202, (ii) process data from the source of laser light 202 and the detector 216, such as relational information between the projected beam of light 106 and the reflected beam of light 108, and (iii) generate and receive system commands to and from the rotorcraft 100, in response to at least the relational information.

The processor 250 may be implemented or realized with at least one general purpose processor, a content addressable memory, a digital signal processor, an application specific integrated circuit, a field programmable gate array, any suitable programmable logic device, discrete gate or transistor logic, discrete hardware components, or any combination designed to perform the functions described herein. A processor device may be realized as a microprocessor, a microcontroller, or a state machine. Moreover, a processor device may be implemented as a combination of computing devices, e.g., a combination of a digital signal processor and a microprocessor, a plurality of microprocessors, one or more microprocessors in conjunction with a digital signal processor core, or any other such configuration. The processor 250 may be realized as an onboard component of a vehicle (e.g., an onboard management system, central maintenance computer, a rotorcraft control system, health and usage monitoring systems (HUMS) or the like), or it may be realized in a portable computing device that is carried onboard the vehicle.

The memory 252 can be realized as RAM memory, flash memory, EPROM memory, EEPROM memory, registers, a hard disk, a removable disk, a CD-ROM, or any other form of storage medium known in the art. In this regard, the memory can be coupled to the processor such that the processor can read information from, and write information to, the memory. In the alternative, memory may be integral to the on-board processor 250. In practice, a functional or logical module/component of the system described here might be realized using program code that is maintained in the memory, or in separately located memory. Moreover, the memory can be used to store data utilized to support the operation of the system, as will become apparent from the following description.

The optical assembly 204 may comprise a first focusing lens 220 and one or more optional lenses 218. The first focusing lens 220 and any optional lenses 218 are selected to cooperate in the capture, redirection, and focusing of the projected beam of light 106, toward the target 214. The size, thickness, and attributes of the components of the optical assembly 204 are selected as appropriate for a desired application.

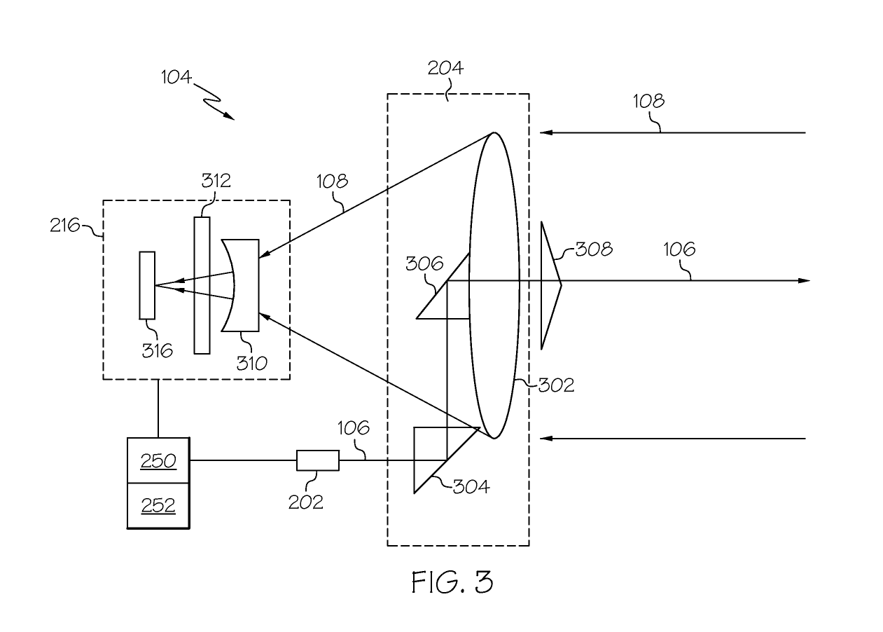

The source of laser light 202 and optical assembly 204 is application specific and chosen to ensure that the projected beam of light 106 comprises the required predetermined spectral characteristics along the predetermined range of distances. Various embodiments of the optical assembly 204 are contemplated. In an embodiment described in further detail in connection with FIG. 3, the first focusing lens 220 comprises a collimating lens.

FIG. 3 is an illustration showing additional detail of the light beam blade tracking system 104 of FIG. 2, in accordance with an exemplary embodiment. FIG. 3 is not to scale but provides a visual appreciation for the relative position and orientation of components and features according to the embodiment. Detector 216 comprises lens 310, and bandpass filter 312, each configured to coordinate in directing reflected beam of light 108 toward detector element 316.

A first folding element 306 and a second folding element 304 are each coupled to the source of laser light 202 and a first lens 302 that is a collimating lens. The first folding element 306 and second folding element 304 may be any mirror or optical device suitable for cooperating in redirecting the projected beam of light 106 from the source of laser light 202, through the collimating first lens 302, and toward the target 214 (not shown).

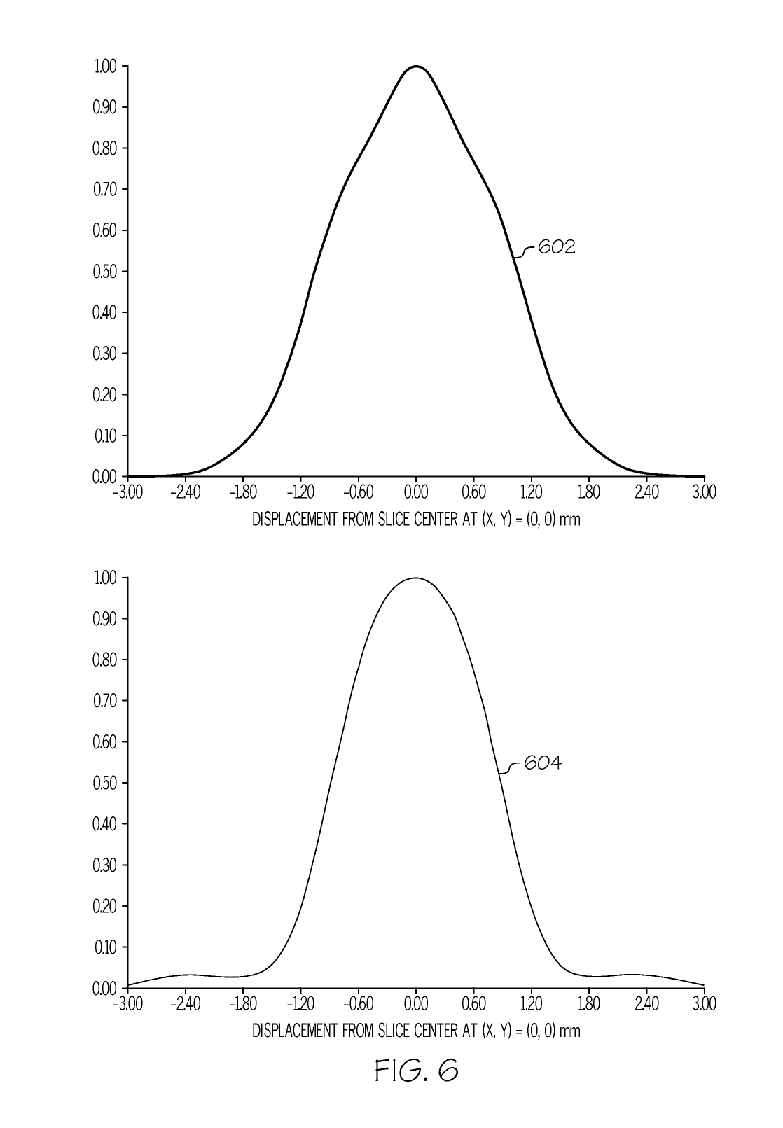

An axicon, also referred to as a rotationally symmetric prism, generally looks like a cone. An axicon is technically a lens having one plano surface and one conical surface. An axicon clarifies or focuses the intensity profile of the projected beam of light at the spot (FIGS. 6-8 provide intensity profiles for comparison). Axicon 308 may be any commercially available rotationally symmetric prism. Axicon 308 is coupled to, and cooperates with, the collimating first lens 302 to direct and focus the projected beam of light 106 to a focal length coincident with the target 214 (not shown), creating the above described spot meeting the requirements of the specific application.

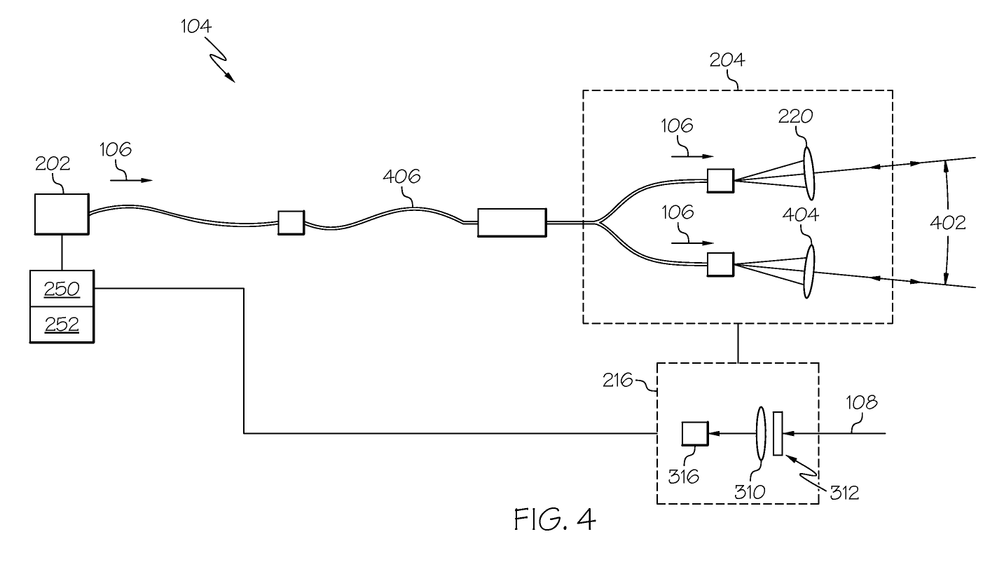

FIG. 4 is an illustration showing additional detail of the light beam blade tracking system 104 of FIG. 2, in accordance with another exemplary embodiment. FIG. 4 is not to scale but provides a visual appreciation for the relative position and orientation of components and features according to the embodiment. Source of laser light 202 is depicted as a laser diode connected via an optional 50/50 fiber coupler 406 to a first focusing lens 220 and an optional second focusing lens 404 that forms a timing gate. The first focusing lens 220 and second focusing lens 404 are oriented to tilt away from each other such that their axis define angle 402. Angle 402 is variable, and chosen to optimize light beam blade tracking system 104 to a desired application. In an embodiment, angle 402 may extend from about 5 degrees to about 20 degrees. In FIG. 4, detector 216 comprises lens 310 and bandpass filter 312, each configured to coordinate in directing reflected beam of light 108 toward detector element 316, as described hereinabove. This embodiment is referred to as a non-coaxial form (projecting leg and detecting leg are non-coaxial) with a timing gate.

FIG. 5 is an illustration showing additional detail of the light beam blade tracking system 104 of FIG. 2, in accordance with yet another exemplary embodiment. FIG. 5 is not to scale but provides a visual appreciation for the relative position and orientation of components and features according to the embodiment. FIG. 5 shares the simple non-coaxial form and timing gate with FIG. 4. In FIG. 5, optional bandpass filter 312 and optional bandpass filter 502 are located between the respective focusing lens and target 214 (not shown). In another embodiment, bandpass filter 504 may be coupled to detector element 316.

FIGS. 6-8 provide a visual appreciation of the consistent, focused, and controlled spectral characteristics of the projected beam of light 106 provided by the embodiments described herein. Specifically, FIGS. 6-8 illustrate intensity profiles located at various distances from the optical assembly 204. The effect of an axicon on the intensity profile is observable. As mentioned above, embodiments employing an axicon also employ a collimating lens for first focusing lens 220.

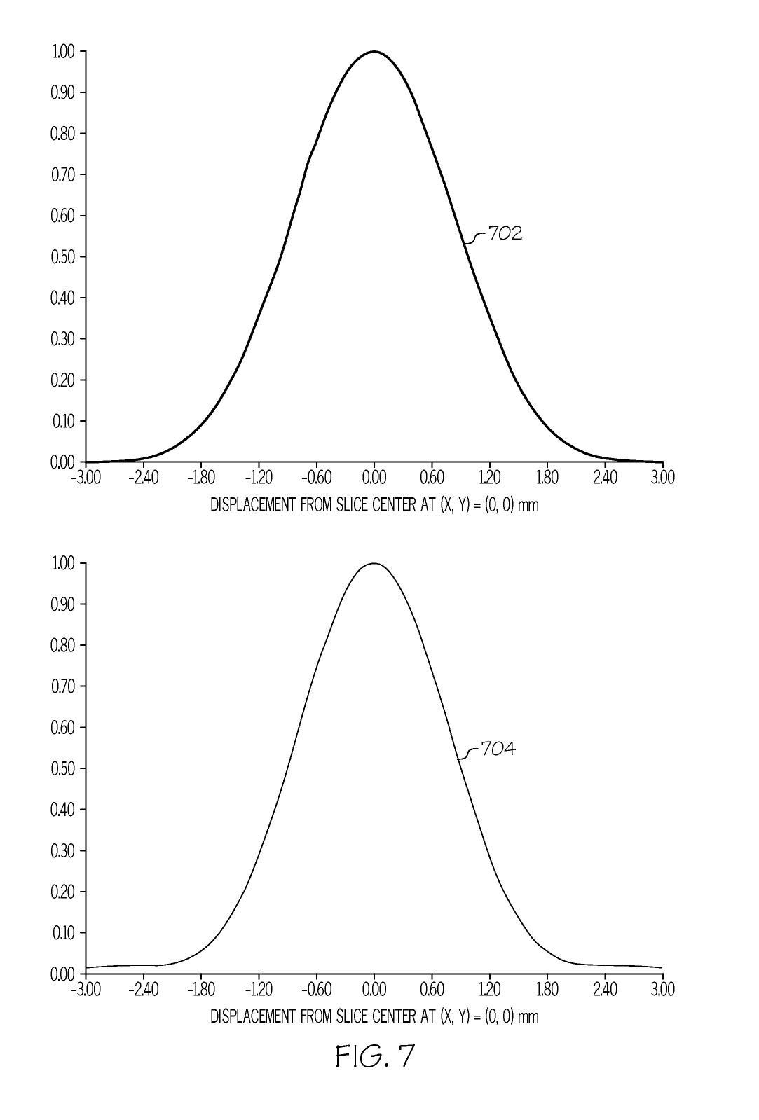

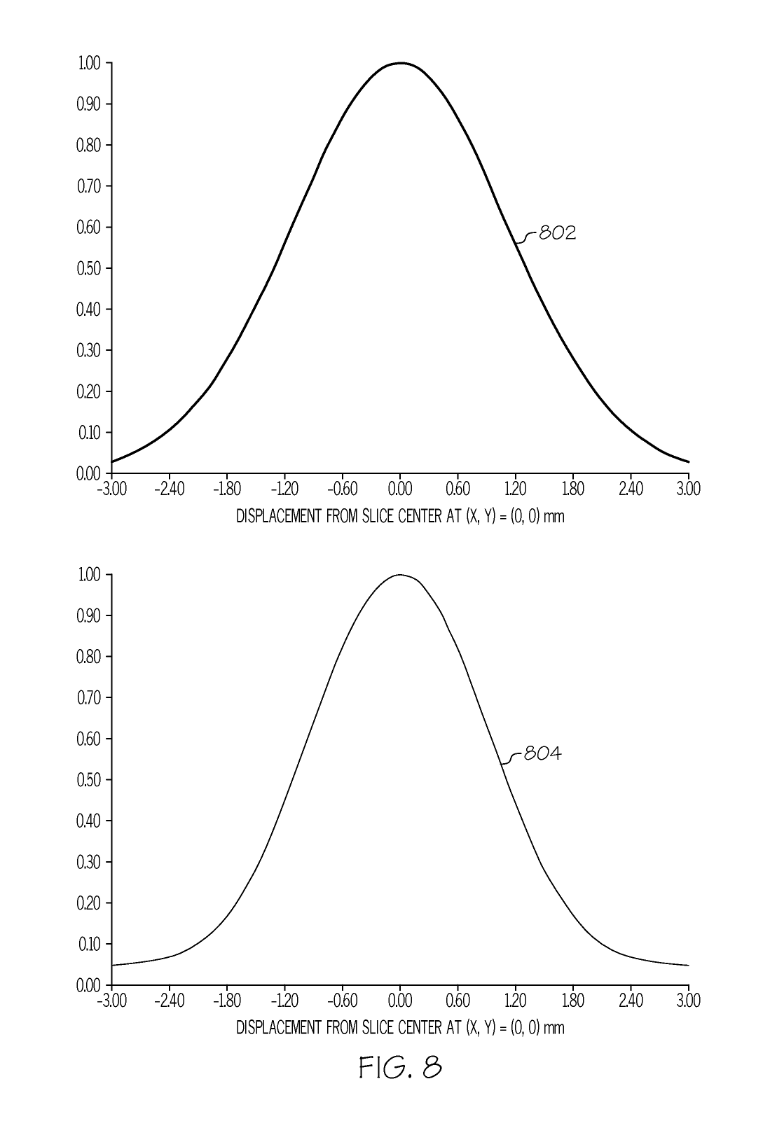

FIG. 6 is an intensity profile comparison at 5 meters. In FIG. 6, the spot on the target is located 5 meters from the optical assembly 204. The intensity profile shown in signal 602 is an embodiment that does not employ an axicon and the intensity profile shown in signal 604 does employ an axicon. FIG. 7 is an intensity profile comparison at 10 meters. In FIG. 7, the spot on the target is located 10 meters from the optical assembly 204. The intensity profile shown in signal 702 is an embodiment that does not employ an axicon and the intensity profile shown in signal 704 does employ an axicon. FIG. 8 is an intensity profile comparison at 12 meters. In FIG. 8, the spot on the target is located 12 meters from the optical assembly 204. The intensity profile shown in signal 802 is an embodiment that does not employ an axicon and the intensity profile shown in signal 804 does employ an axicon.

Thus, an improved rotorcraft blade tracking system and method is provided. The provided blade tracking system and method projects a focused beam of light with minimal variance in predetermined spectral characteristics at the ranges of distance suitable for rotorcraft blade tracking applications. The provided system and method detects a reflected beam of light that is associated with the projected focused beam of light. The provided system and method maintains eye safety, and performs consistently over a variety of environmental conditions.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A blade tracking system for a rotorcraft, the system comprising:
a light source mounted on the rotorcraft and configured to generate a projected beam of light sufficient to impinge on a target on a blade of the rotorcraft, the target separated by a predetermined distance from the light source;
an optical assembly coupled to the light source, and oriented to (i) direct the projected beam of light toward the target and (ii) focus the projected beam of light, such that the projected beam of light provides predetermined spectral characteristics along a predetermined range of distances; and
a detector coupled to the light source and the optical assembly and configured to detect from the target, a reflected beam of light associated with the projected beam of light.

2. The display system of claim 1, wherein the predetermined spectral characteristics comprise at least one of: (i) predetermined wavelength, (ii) predetermined spatial extent, (iii) predetermined aperture, and (iv) predetermined divergence.

3. The display system of claim 2, wherein the predetermined range of distances is from about 4 meters to about 12 meters.

4. The display system of claim 4, wherein the predetermined spectral characteristics comprise a spot that is a substantially circular area having a diameter within a range of from about 2 millimeters to about 5 millimeters.

5. The display system of claim 3, further comprising a bandpass filter coupled to at least one of (i) the optical assembly and (ii) the detector, and configured to pass the reflected beam of light.

6. The display system of claim 1, wherein the optical assembly comprises a focusing lens.

7. The display system of claim 6, wherein the focusing lens comprises a collimating lens, and further comprising an axicon coupled to the optical assembly and configured to cooperate with the collimating lens directing the projected beam of light toward the target and focusing the projected beam of light, such that it provides predetermined spectral characteristics along the predetermined range of distances.

8. The display system of claim 7, wherein the optical assembly further comprises a first folding element and a second folding element; and wherein the first folding element and the second folding element are configured to redirect the projected beam of light.

9. The display system of claim 1, wherein the light source comprises at least one of an optical fiber laser source or a laser diode.

10. The display system of claim 1, wherein the light source comprises a controlled laser.

11. A blade tracking system for a rotorcraft, the blade tracking system comprising:
a light source mounted on the rotorcraft and configured to generate a projected beam of light;
an optical assembly coupled to the light source and oriented to (i) direct the projected beam of light such that it impinges on a target located on a blade of the rotorcraft, (ii) focus the projected beam of light, such that the projected beam of light comprises at least one predetermined spectral characteristic from the set of: (i) predetermined wavelength, (ii) predetermined spatial extent, (iii) predetermined aperture, and (iv) predetermined divergence along a predetermined range of distances; and
a detector coupled to the optical assembly and the light source, the detector oriented to detect, from the target, a reflected beam of light associated with the projected beam of light.

12. The display system of claim 11, wherein the optical assembly comprises a collimating lens, and further comprising an axicon coupled to the optical assembly and configured to cooperate with the collimating lens in the redirection of the projected beam onto the target.

13. The display system of claim 11, wherein the optical assembly comprises a focusing lens.

14. The display system of claim 13, wherein the optical assembly further comprises a first folding element and a second folding element; wherein the first folding element and the second folding element are configured to redirect the projected beam of light.

15. The display system of claim 14, further comprising a bandpass filter coupled to the optical assembly and configured to pass wavelengths of the reflected beam of light.

16. The display system of claim 14, further comprising a bandpass filter coupled to the detector and configured to pass wavelengths of the reflected beam of light.

17. The display system of claim 14, wherein the predetermined range of distances is from about 4 meters to about 12 meters from the optical assembly

18. A method for tracking a blade on a rotorcraft, the method comprising:
generating, by a light source, a projected beam of light;
redirecting, by an optical assembly, the projected beam of light toward a target located on a blade of the rotorcraft that is within a predetermined range of distances;
focusing the projected beam of light such that the projected beam of light is characterized by at least one of: (i) predetermined wavelength, (ii) predetermined spatial extent, (iii) predetermined aperture, and (iv) predetermined divergence; and
detecting, by a detector, a reflected beam of light from the target.

19. The method of claim 18, wherein the step of focusing the projected beam of light comprises defining a spot on the target, the spot having a diameter of substantially 3 millimeters.

20. The method of claim 19, wherein the predetermined range of distances is from about 4 meters to about 12 meters from the light source
